(19) United States
(12) Patent Application Publication
(10) Pub. No.: US 2009/0070026 A1
(43) Pub. Date: Mar. 12, 2009

(54) In-vehicle communication apparatuses, methods, and programs

(75) Inventor: Tomoki Kubota, Okazaki (JP)

Correspondence Address: OLIFF & BERRIDGE, PLC, P.O. BOX 320850, ALEXANDRIA, VA, 22320-4850, US

(73) Assignee: AISIN AW CO., LTD., Anjo-shi (JP)

(21) Appl. No.: 12/230,740

(22) Filed: Sep. 4, 2008

(30) Foreign Application Priority Data
Sep. 7, 2007 (JP) 2007-232999

(51) Int. Cl. G08G 1/16; G08G 1/09; G06F 19/00

(52) U.S. Cl. 701/117; 701/301

(57) ABSTRACT

In-vehicle communication apparatuses, methods, and programs store a database including a plurality of points set within the vicinity of an intersection and a plurality of frequencies associated with a each of the points. The apparatuses, methods, and programs receive a signal and detect a frequency of the received signal. The apparatuses, methods, and programs generate content of a warning about the intersection based on the stored database and the detected frequency and communicate the generated content of the warning.

### INCORPORATION BY REFERENCE

The disclosure of Japanese Patent Application No. 2007-232999 filed on Sep. 7, 2007, including the specification, drawings and abstract thereof, is incorporated herein by reference in its entirety.

### BACKGROUND

1. Related Technical Fields

Related technical fields include communication apparatuses, methods, and programs that provide support to a driver for avoiding collisions at intersections.

2. Related Art

Communication with other vehicles has been used in order to avoid collisions at intersections. In inter-vehicle communication disclosed in Japanese Unexamined Patent Application Publication No. 2000-207679, a signal having a frequency associated with the traveling position of a transmitting vehicle is transmitted, and a vehicle having received the signal can detect the position of the transmitting vehicle.

### SUMMARY

In the inter-vehicle communication described above, when a transmit frequency is being used (transmitted), a subsequent transmission using the transmitted frequency cannot occur until the original transmission is complete. Accordingly, when multiple vehicles are entering an intersection, the first vehicle to enter the intersection can transmit a signal, but any subsequent vehicles cannot transmit a signal without interference. It is thus impossible to inform other vehicles of the presence of any subsequent vehicles. Vehicles that cannot recognize the presence of a subsequent vehicle may collide with the subsequent vehicle at the intersection.

Accordingly, exemplary implementations of the broad inventive principles described herein provide a communication technique for recognizing another vehicle entering an intersection using and a communication technique for informing another vehicle of a vehicle's entry into an intersection.

Exemplary implementations provide apparatuses, methods, and programs that store a database including a plurality of points set within the vicinity of an intersection and a plurality of frequencies associated with a each of the points. The apparatuses, methods, and programs receive a signal and detect a frequency of the received signal. The apparatuses, methods, and programs generate content of a warning about the intersection based on the stored database and the detected frequency and communicate the generated content of the warning.

### BRIEF DESCRIPTION OF THE DRAWINGS

Exemplary implementations will now be described with reference to the accompanying drawings, wherein:

FIG. 1 is a block diagram schematically illustrating main components of an exemplary system configuration;

FIG. 2 is a flowchart of an exemplary reception method;

FIG. 3 is a table showing an example of the content of a node-frequency database (DB);

FIG. 4 is an illustration of the relationship among vehicles and nodes at an intersection;

FIG. 5 is a flowchart of an exemplary signal receiving method;

FIG. 6 is an illustration of the relationship among vehicles and nodes at an intersection;

FIG. 7 is a flowchart of an exemplary signal receiving method;

FIG. 8 is a flowchart of an exemplary signal receiving method;

FIG. 9 is a flowchart of an exemplary transmission method; and

FIG. 10 is a flowchart of an exemplary signal transmitting method.

### DETAILED DESCRIPTION OF EXEMPLARY IMPLEMENTATIONS

An exemplary in-vehicle communication apparatus will be described in detail with reference to the drawings. In this specification, the term “intersection” is used to refer to a point where roads intersect and includes the definition defined by traffic laws.

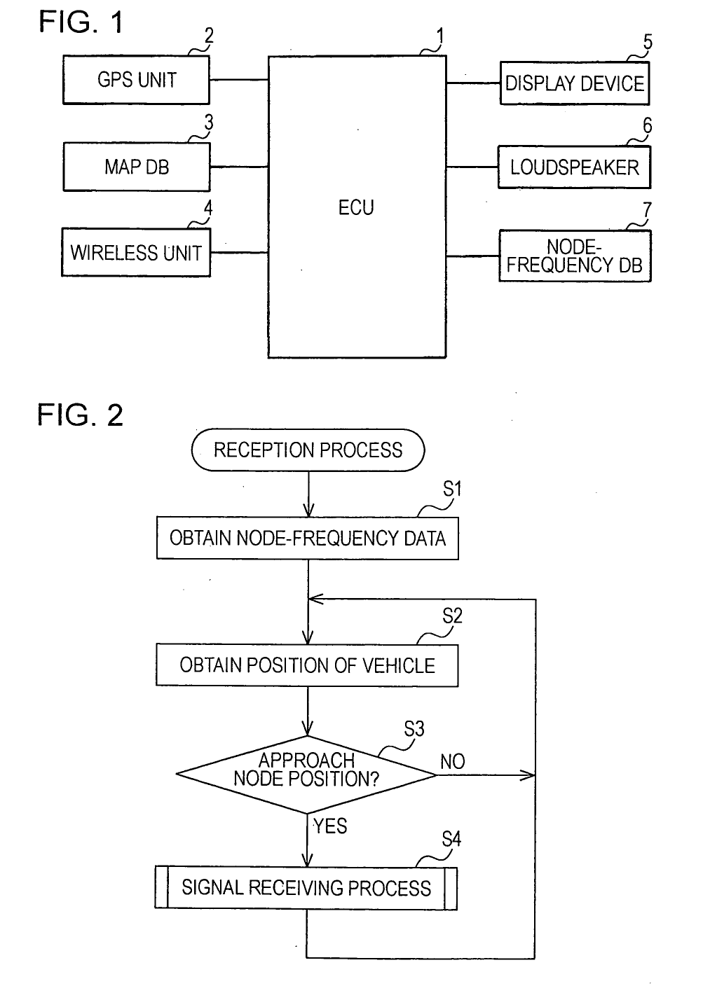

Referring to FIG. 1, the system configuration of the in-vehicle communication apparatus according to the present example is described. FIG. 1 is a block diagram schematically illustrating main components of the system configuration of the in-vehicle communication apparatus. As shown in FIG. 1, the in-vehicle communication apparatus according to the present example includes an electronic control unit (ECU) 1, a Global Positioning System (GPS) unit 2, a map database (DB) 3, a wireless unit 4, a display device 5, a loudspeaker 6, and a node-frequency DB 7. The configuration shown in FIG. 1 includes portions that are necessary for the description of the present example. The in-vehicle communication apparatus may include various other components that are not shown in the block diagram.

The ECU 1 performs electronic control of the overall vehicle in which the in-vehicle communication apparatus is provided. The ECU 1 mainly includes an input interface that converts input signals from various devices, a controller such as a computer unit (microcomputer) that performs arithmetic operations of input data according to predetermined procedures and/or programs, and an output interface that converts the arithmetic results into actuator activating signals. The ECU 1 controls various components that are connected thereto.

The GPS unit 2 detects the position of the vehicle by measuring the arrival time of a radio wave emitted from an artificial satellite and calculating the distance from the artificial satellite. The GPS unit 2 is a component of a navigation system (not shown).

The map DB 3 stores various items of map data necessary for displaying route guidance, traffic information guidance, and maps. The map DB 3 is used in the navigation system (not shown). The map DB 3 includes node data and link data. An item of node data defines a predetermined position on a road using a node identification (node numbers), node coordinates (latitude and longitude), and the like. An item of link data defines a link ID, a link length, the coordinates of the start node and the termination node of a link, and the like. A link is defined between nodes.

The wireless unit 4 is configured to communicate with in-vehicle communication apparatuses provided in other vehicles. The wireless unit 4 can transmit and receive predetermined frequency signals whose band is not restricted. Various devices that are heretofore known can be used as the wireless unit 4.

The display device 5 is also constructed as part of the navigation system (not shown) and displays the position of the vehicle and roads. The display device 5 is also used to give various warnings to a user. The display device 5 may be implemented by a liquid crystal display or may be constructed as a touch panel display.

The loudspeaker 6 is also constructed as part of the navigation system (not shown) and used to output sounds giving route guidance, warnings, and the like. The loudspeaker 6 may also be shared by a music player (not shown).

The node-frequency DB 7 stores data in which a plurality of frequencies are associated with a point set in the vicinity of an intersection. The node-frequency DB 7 will be described in detail later. The content of the node-frequency DB 7 is common to vehicles.

FIG. 2 is a flowchart illustrating an exemplary reception method. The exemplary method may be implemented, for example, by one or more components of the above-described in-vehicle communication apparatus. For example, the exemplary method may be implemented by the ECU 1 executing a computer program stored in a computer- readable medium such as a ROM. However, even though the exemplary structure of the above-described in-vehicle communication apparatus may be referenced in the description, it should be appreciated that the structure is exemplary and the exemplary method need not be limited by any of the above-described exemplary structure.

This exemplary method is executed while the vehicle is traveling. The in-vehicle communication apparatus may be configured to manually turn on/off a reception process implementing the method.

In step S1, node-frequency data, which is stored in the node-frequency DB 7, is obtained. The content of the node-frequency DB 7 may be distributed from a center (not shown). Alternatively, the in-vehicle communication apparatus may not include node-frequency data and may obtain node-frequency data from the center (not shown) as needed. In that case, the node-frequency DB 7 is not necessary in the vehicle.

An example of the node-frequency data stored in the node-frequency DB 7 will be described with reference to FIG. 3. As shown in FIG. 3, a plurality of nodes are defined for each intersection, and a plurality of frequencies are associated with each of the nodes. The individual nodes are defined using node numbers. In the following description, points corresponding to nodes are called node positions. The node numbers stored in the node-frequency DB 7 are common to node numbers in the map DB 3. Coordinate information corresponding to each of the node numbers can be obtained by referring to the map DB 3. Accordingly, the coordinate information in FIG. 3 may be omitted. The same applies to road links.

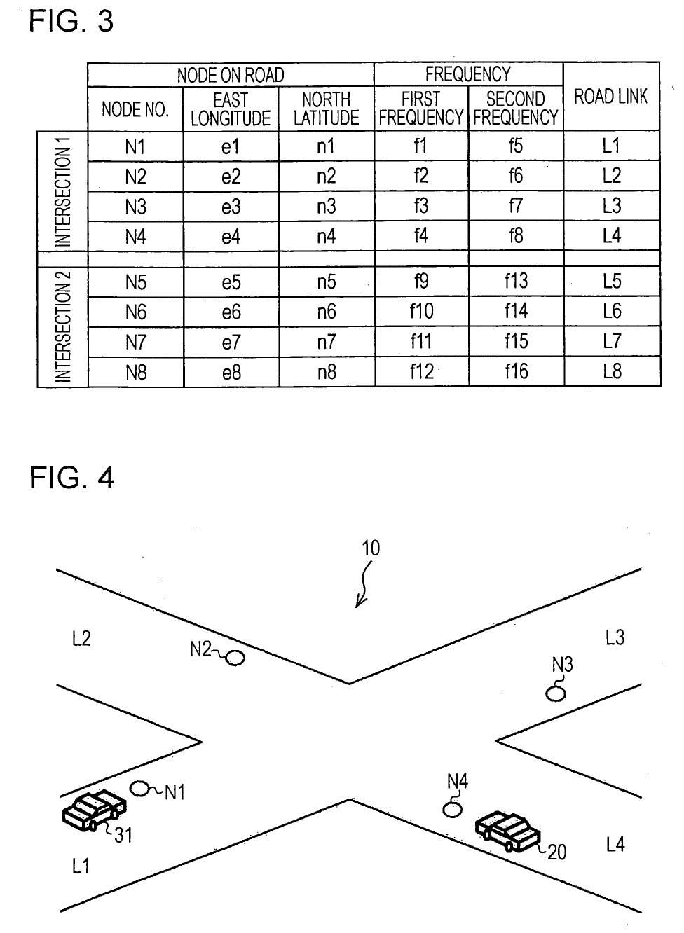

FIG. 4 illustrates the outline of node positions in the vicinity of an intersection 10. As shown in FIG. 4, nodes N1 to N4 are defined at predetermined points on roads in the vicinity of the intersection 10. The node positions of the nodes N1 to N4 are located near but outside the intersection 10. The node positions can be arbitrarily set.

Referring back to FIG. 2, in step S2, the position of the vehicle is obtained using the GPS unit 2. In step S3, it is determined, on the basis of the obtained position of the vehicle, whether the vehicle has approached one of the node positions defined in the node-frequency DB 7. Alternatively, it can be set to determine in step S3 whether the vehicle has passed through one of the node positions.

When it is determined that the vehicle has not yet approached one of the node positions (NO in step S3), the method returns to step S2. That is, steps S2 and S3 are looped until the vehicle has approached one of the node positions.

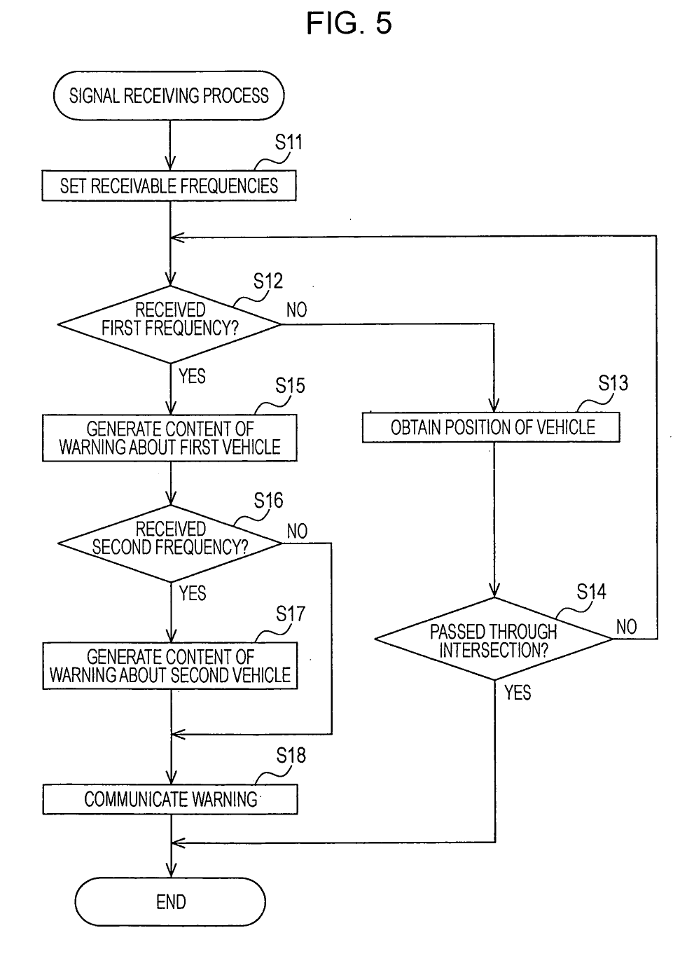

When it is determined that the vehicle has approached one of the node positions (YES in step S3), the method proceeds to a signal receiving process in step S4. This signal receiving process may be implemented by the exemplary signal receiving method shown in FIG. 5.

The exemplary method of FIG. 5 may be implemented, for example, by one or more components of the above-described in-vehicle communication apparatus. For example, the exemplary method may be implemented by the ECU 1 executing a computer program stored in a computer-readable medium such as a ROM. However, even though the exemplary structure of the above-described in-vehicle communication apparatus may be referenced in the description, it should be appreciated that the structure is exemplary and the exemplary method need not be limited by any of the above-described exemplary structure.

As shown in FIG. 5, in step S11, receivable frequencies are set. In the example illustrated in FIG. 4, road links (L1 and L3 in this case) intersecting a road link L4 on which a vehicle 20 is present are specified. Frequencies associated with node positions (N1 and N3 in this case) on the specified road links are determined as receivable frequencies. That is, a frequency f1 associated with the node N1 and a frequency f3 associated with the node N3 are set as first frequencies. A frequency f5 associated with the node N1 and a frequency f7 associated with the node N3 are determined as second frequencies. Alternatively, frequencies associated with only one of the nodes may be set as receivable frequencies.

In step S12, it is determined whether one of the first frequencies set in step S11 has been received. When it is determined that one of the first frequencies has not been received (NO in step S12), the method proceeds to step S13. In step S13, the position of the vehicle is obtained using the GPS unit 2. After the position of the vehicle is obtained, the method proceeds to step S14.

In step S14, it is determined, on the basis of the obtained position of the vehicle, whether the vehicle has passed through the intersection. When it is determined that the vehicle has not passed through the intersection (NO in step S14), the method returns to step S12. When it is determined that the vehicle has passed through the intersection (YES in step S14), the signal receiving method ends.

When it is determined that one of the first frequencies has been received (YES in step S12), the method proceeds to step S15. In this case, a first vehicle's entry into the intersection can be recognized by receiving this first frequency.

In step S15, the content of a warning indicating that the first vehicle is trying to enter the intersection is generated. In step S16, it is determined whether one of the second frequencies has been received. When it is determined that one of the second frequencies has not been received (NO in step S16), the method proceeds to step S18. In contrast, when it is determined that one of the second frequencies has been received (YES in step S16), the method proceeds to step S17. In this case, the fact that two vehicles are successively entering the intersection is recognized by receiving this second frequency.

In step S17, the content of a warning indicating that the second vehicle is trying to enter the intersection is generated. In step S18, the content of the warning(s) generated in step S15 or in steps S15 and S17 is communicated using, for example, the display device 5 and/or the loudspeaker 6. The generated content of the warning(s) may be communicated using light, vibration, displaying an image, outputting sound, and/or the like. In this case, various devices (not shown) are used as needed to communicate the content of the warning(s).

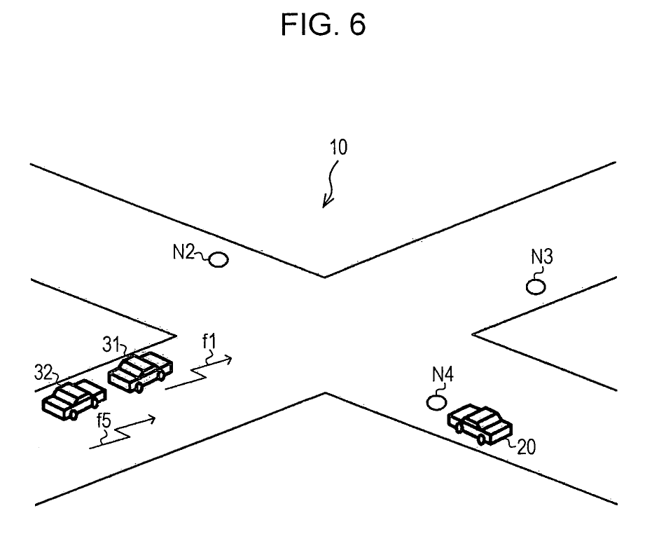

According to the above-described reception method, for example, as shown in FIG. 6, when other vehicles 31 and 32 are trying to enter the intersection 10 in succession, the vehicle 31 transmits a signal having the frequency f1, and the vehicle 32 transmits a signal having the frequency f5. The vehicle 20 receives these two frequencies and recognizes that the other two vehicles 31 and 32 are entering the intersection 10. By communicating the content of a warning in accordance with the situation, a collision at the intersection 10 can be avoided.

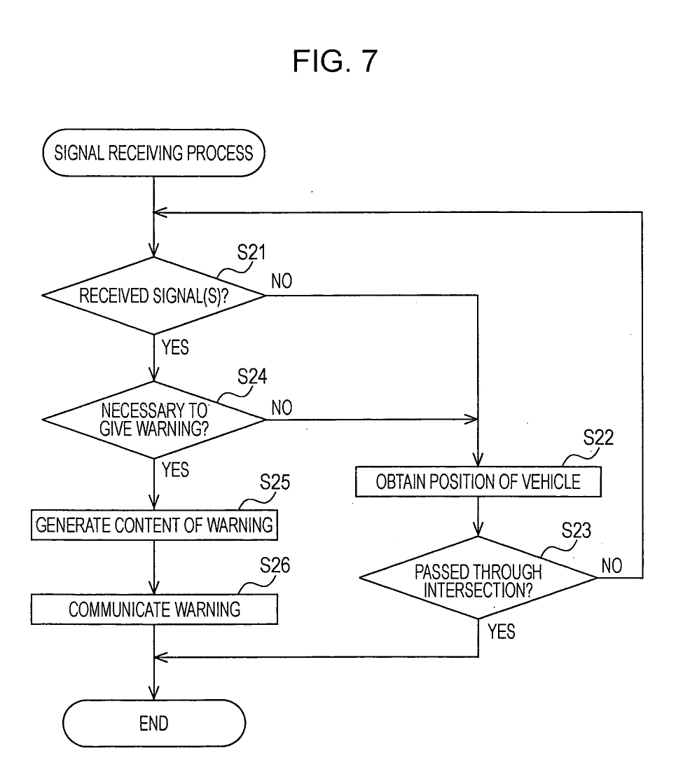

Next, another exemplary signal receiving method will be described with reference to FIG. 7. The exemplary method may be implemented, for example, by one or more components of the above-described in-vehicle communication apparatus. For example, the exemplary method may be implemented by the ECU 1 executing a computer program stored in a computer-readable medium such as a ROM. However, even though the exemplary structure of the above-described in-vehicle communication apparatus may be referenced in the description, it should be appreciated that the structure is exemplary and the exemplary method need not be limited by any of the above-described exemplary structure.

In step S21, it is determined whether a signal(s) has been received. In step S21, it is only necessary to determine whether a signal(s) has been received, and it is unnecessary to identify a reception frequency(ies). When it is determined that no signal has been received (NO in step S21), the method proceeds to step S22.

The processing in steps S22 and S23 is the same as the processing in step S13 and S14 of FIG. 5. Thus, a description thereof is not repeated.

When it is determined that a signal(s) has been received (YES in step S21), the process proceeds to step S24. In step S24, it is determined whether the frequency(ies) of the received signal(s) is a frequency about which a warning needs to be given. For example, in the example illustrated in FIG. 4, it is determined whether the frequency of the received signal is a frequency transmitted from another vehicle present at the position corresponding to the node N1 or another vehicle present at the position corresponding to the node N3. That is, it is determined whether the frequency of the received signal is one of the receivable frequencies f1 and f5 (associated with the node position N1) or f3 and f7 (associated with the node position N3). This step is performed by referring to the node-frequency DB 7.

When it is determined that no warning needs to be given (NO in step S24), the method proceeds to step S22. When the frequency(ies) of the received signal(s) is not one of the receivable frequencies, it is determined that no warning needs to be given, and the method proceeds to step S22. In contrast, when it is determined that a warning needs to be given (YES in step S24), in step S25, the process generates the content of a warning. The content of the warning is different depending on whether the received frequency(ies) includes only one of the first frequencies or both one of the first frequencies and a corresponding one of the second frequencies. Specifically, when one of the second frequencies is received (that is, when other vehicles are trying to enter the intersection in succession), the level of a warning may be increased. For example, when only one of the first frequencies is received, a predetermined warning sound may be communicated. When one of the first frequencies and a corresponding one of the second frequencies are received, besides a warning sound, a warning message may additionally be communicated. The volume of a warning sound communicated when one of the first frequencies and a corresponding one of the second frequencies are received may be made louder than the volume of a warning sound communicated when only one of the first frequencies is received.

In step S26, the content of the warning generated in step S25 is communicated. Since this processing is the same as step S18 of FIG. 5, a description thereof is not repeated.

Even in the above-described signal receiving process, for example, as shown in FIG. 6, when the vehicle 31 and the vehicle 32 are trying to enter the intersection 10 in succession, the vehicle 31 transmits a signal having the frequency f1, and the vehicle 32 transmits a signal having the frequency f5. The vehicle 20 receives these two frequencies and recognizes that the other two vehicles 31 and 32 are entering the intersection 10. By communicating the content of a warning in accordance with the situation, a collision at the intersection 10 can be avoided.

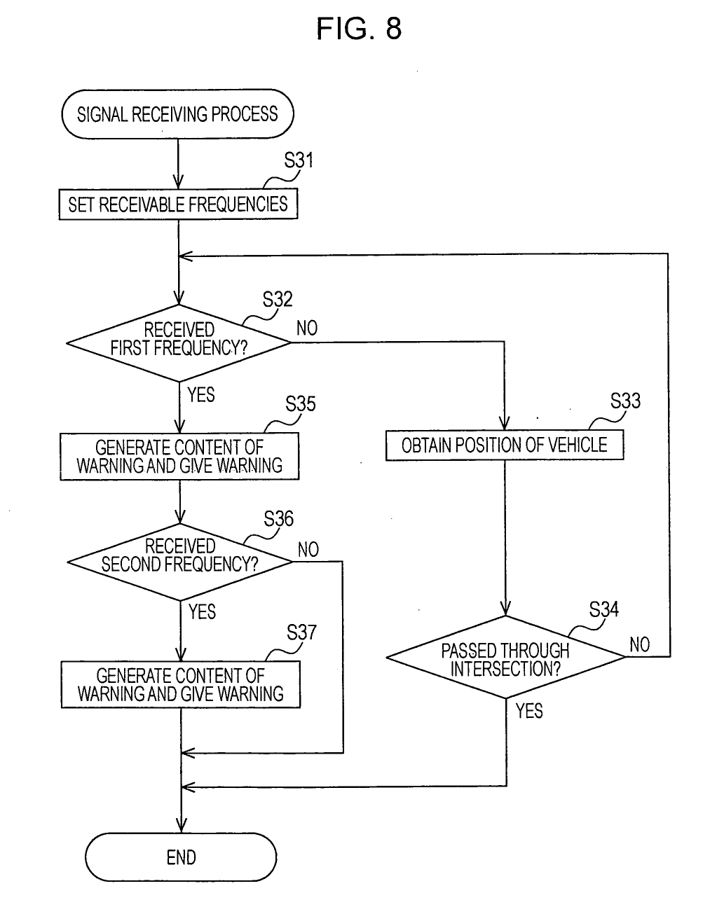

Next, another exemplary signal receiving method will be described with reference to FIG. 8. The exemplary method may be implemented, for example, by one or more components of the above-described in-vehicle communication apparatus. For example, the exemplary method may be implemented by the ECU 1 executing a computer program stored in a computer-readable medium such as a ROM. However, even though the exemplary structure of the above-described in-vehicle communication apparatus may be referenced in the description, it should be appreciated that the structure is exemplary and the exemplary method need not be limited by any of the above-described exemplary structure.

The signal receiving process according to the present example generates, as illustrated in steps S32, S35, S36, and S37, the content of a warning every time one of the receivable frequencies set in step S31 is received and communicates the generated content of the warning. According to the present example, every time one of the receivable frequencies is received, the messages “the first vehicle is approaching,” “the second vehicle is approaching,” and so forth can be sequentially displayed on the display device 5. Also, sounds of the messages “the first vehicle is approaching,” “the second vehicle is approaching,” and so forth can be sequentially output from the loudspeaker 6. Accordingly, the vehicle can be informed step-by-step of the presence of other vehicles entering the intersection. Since the processing in steps S33 and S34 is similar to the processing in steps S13 and S14 of FIG. 5, a description thereof is not repeated.

The above-described signal receiving processes may be configured not only to communicate a warning indicating another vehicle's entry into an intersection, but also to forcedly apply brakes in response to the possibility of a collision.

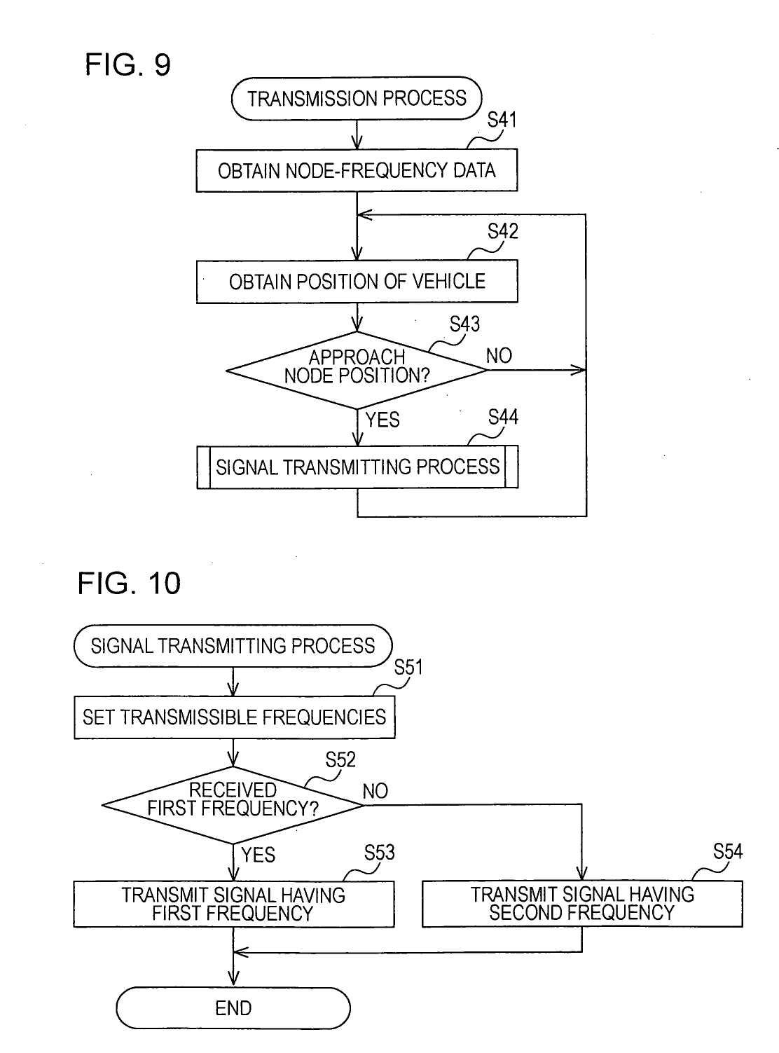

An exemplary transmission process according to an example of the present example will be described with reference to FIG. 9. The exemplary method may be implemented, for example, by one or more components of the above-described in-vehicle communication apparatus. For example, the exemplary method may be implemented by the ECU 1 executing a computer program stored in a computer-readable medium such as a ROM. However, even though the exemplary structure of the above-described in-vehicle communication apparatus may be referenced in the description, it should be appreciated that the structure is exemplary and the exemplary method need not be limited by any of the above-described exemplary structure.

This exemplary method is executed while the vehicle is traveling. The in-vehicle communication apparatus may be configured to manually turn on/off a transmission process implementing the exemplary method. According to the present invention, the in-vehicle communication apparatus may be configured to perform only a reception method or the transmission method. Alternatively, the in-vehicle communication apparatus may alternately perform a reception process and the transmission process or may perform both a reception process and the transmission process in parallel.

In the flowchart shown in FIG. 9, basically a process similar to the flowchart of the reception process shown in FIG. 2 is performed. The only difference resides in that a signal transmitting process is performed when the vehicle approaches a node position. The signal transmitting process may be implemented by the exemplary method of FIG. 10.

FIG. 10 is a flowchart of an exemplary signal transmitting process. The exemplary method may be implemented, for example, by one or more components of the above-described in-vehicle communication apparatus. For example, the exemplary method may be implemented by the ECU 1 executing a computer program stored in a computer-readable medium such as a ROM. However, even though the exemplary structure of the above-described in-vehicle communication apparatus may be referenced in the description, it should be appreciated that the structure is exemplary and the exemplary method need not be limited by any of the above-described exemplary structure.

In step S51, transmissible frequencies are set. The transmissible frequencies are set by using the position of the vehicle and the node-frequency DB 7. In the example illustrated in FIG. 4, because the vehicle 20 is located near the node N4, the frequency f4 is set as the first frequency, and the frequency f8 is set as the second frequency. In step S52, it is determined whether a first frequency is received to determine whether the first frequency is being used by another vehicle. That is, when another vehicle is using the first frequency, the vehicle 20 will receive that first frequency.

When it is determined that the first frequency is received (YES in step S52), the process proceeds to step S53. In step S53, because it is determined that the first frequency is being used, the second frequency is determined as a transmission frequency, and a signal having the second frequency is transmitted. In contrast, when it is determined that the first frequency is not being received (NO in step S52), the process proceeds to step S54 where the first frequency is determined as a transmission frequency, and a signal having the first frequency is transmitted. Accordingly, in the example illustrated in FIG. 4, the vehicle 20 transmits a signal having the frequency f4 since the vehicle 20 is the first vehicle trying to enter the intersection 10 (that is, the vehicle 20 is not entering the intersection after any other vehicles).

According to the above-described transmission process, a signal is transmitted using an unused one of a plurality of frequencies associated with a node. Thus, even when a vehicle is entering an intersection subsequent to another vehicle, the vehicle can transmit a signal. In the foregoing examples, two frequencies are defined for each node. However, the number of frequencies defined for each node is not limited two. Three, four, or more frequencies may be defined for each node.

As has been described above, by transmitting/receiving a signal having a predetermined frequency in the vicinity of an intersection, a vehicle can easily recognize another vehicle's entry into the intersection and inform other vehicles of the vehicle's entry into the intersection. Because the reception process and the transmission process according to the foregoing examples are simple processes, a collision avoiding process that requires immediacy and timeliness can be performed. Thus, even in a situation where multiple vehicles successively enter an intersection, the situation can be handled in an appropriate manner.

While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

For example, the order and arrangement of the steps in the flowcharts are only examples. Changing the order, deletion, and replacement of some of the steps of the above-described flowcharts and addition of other steps to the above-described flowcharts can be done as needed.

In the foregoing examples, different communication channels are provided by changing the frequency. Alternatively, multiple communication channels can be provided by changing the phase and/or amplitude of a signal. Transmitted/received signals may be analog or digital. A plurality of signals can be transmitted using time-division multiplexing.

According to the foregoing examples, information regarding a vehicle can be communicated simply by transmitting/receiving a signal having a predetermined frequency using the node-frequency DB 7 whose content is common to a plurality of vehicles. Furthermore, the foregoing examples have a particular technical advantage that information regarding other vehicles can be obtained.

Although the foregoing description mainly concerns an in-vehicle communication apparatus and methods, the concept can be realized a computer-executable program that causes a computer to execute program instructions implementing one or more of the above described methods. The in-vehicle communication apparatus could be implemented as a computer-readable a recording medium having the computer-executable programs recorded thereon.

What is claimed is:

1. An in-vehicle communication apparatus, comprising:
a memory storing a database including a plurality of points set within the vicinity of an intersection and a plurality of frequencies associated with each of the points; and
a controller that is specifically configured to:
receive a signal;
detect a frequency of the received signal;
generate content of a warning about the intersection based on the database and the detected frequency; and
communicate the generated content of the warning.

2. The in-vehicle communication apparatus according to claim 1, wherein the controller is specifically configured to:
receive a detected current position of a vehicle in which the in-vehicle communication apparatus is provided, the detected current position detected by a current position detector;
determine candidate frequencies for received signals when the detected vehicle position indicates that the vehicle is approaching one of the plurality of points; and
generate the content of the warning when one of the candidate frequencies matches the detected frequency.

3. The in-vehicle communication apparatus according to claim 2, wherein the controller is specifically configured to determine the candidate frequencies based on the database and the detected current position.

4. The in-vehicle communication apparatus according to claim 2, wherein the controller is specifically configured to:
receive a plurality of signals;
detect a plurality of frequencies of the received plurality of signals;
increase a level of the generated warning if the detected plurality of frequencies match a plurality of the candidate frequencies.

5. The in-vehicle communication apparatus according to claim 2, wherein the controller is specifically configured to:
generate and communicate the content of the warning every time one of the candidate frequencies matches the detected frequency.

6. The in-vehicle communication apparatus according to claim 2, wherein the controller is specifically configured to:
set transmissible frequencies based on the database and the detected position of the vehicle;
determine one of the transmissible frequencies that is not currently being used as a transmission frequency; and
transmit a signal having the determined transmission frequency.

7. The in-vehicle communication apparatus according to claim 6, wherein the controller is specifically configured to exclude any frequency of the received signal from the transmissible frequencies.

8. A navigation apparatus comprising the in-vehicle communication apparatus according to claim 2.

9. The navigation apparatus of claim 8, further comprising the current position detector.

10. An in-vehicle communication method, comprising:
storing a database including a plurality of points set within the vicinity of an intersection and a plurality of frequencies associated with each of the points;
receiving a signal;
detecting a frequency of the received signal;
generating content of a warning about the intersection based on the database and the detected frequency; and
communicating the generated content of the warning.

11. The in-vehicle communication method according to claim 10, further comprising:
receiving a detected current position of a vehicle in which the in-vehicle communication apparatus is provided;
determining candidate frequencies for received signals when the detected vehicle position indicates that the vehicle is approaching one of the plurality of points; and
generating the content of the warning when one of the candidate frequencies matches the detected first frequency.

12. The in-vehicle communication method according to claim 11, further comprising determining the candidate frequencies based on the database and the detected current position.

13. The in-vehicle communication method according to claim 11, further comprising:
receiving a plurality of signals;
detecting frequencies of the received plurality of signals;
increasing a level of the generated warning if the detected frequencies match a plurality of the candidate frequencies.

14. The in-vehicle communication method according to claim 11, further comprising generating and communicating the content of the warning every time one of the candidate frequencies matches the detected frequency.

15. The in-vehicle communication method according to claim 11, further comprising:
setting transmissible frequencies based on the database and the detected position of the vehicle;
determining one of the transmissible frequencies that is not currently being used as a transmission frequency; and
transmitting a signal having the determined transmission frequency.

16. The in-vehicle communication method according to claim 15, further comprising excluding the first frequency from the transmissible frequencies.

17. A computer-readable storage medium storing a computer-executable program usable for in-vehicle communication, the program comprising:
instructions for storing a database including a plurality of points set within the vicinity of an intersection and a plurality of frequencies associated with each of the points;
instructions for receiving a signal;
instructions for detecting a frequency of the received signal;
instructions for generating content of a warning about the intersection based on the stored database and the detected frequency; and
instructions for communicating the generated content of the warning.

18. The computer-readable storage medium of claim 17, the program further comprising:
instructions for receiving a detected current position of a vehicle in which the in-vehicle communication apparatus is provided;
instructions for determining candidate frequencies for received signals when the detected vehicle position indicates that the vehicle is approaching one of the plurality of points; and
instructions for generating the content of the warning when one of the candidate frequencies matches the detected frequency.
